(19) United States
(12) Patent Application Publication
(10) Pub. No.: US 2003/0130104 A1
(43) Pub. Date: Jul. 10, 2003

(54) Inorganic fiber and process of producing the same

(76) Inventors: Katsuya Kusuno, Hamamatsu-shi (JP); Satoshi Dohi, Hamamatsu-shi (JP); Hideki Kitahara, Hamamatsu-shi (JP)

Correspondence Address: NIXON & VANDERHYE P.C., 8th Floor, 1100 North Glebe Road, Arlington, VA, 22201, US

(21) Appl. No.: 10/230,371

(22) Filed: Aug. 29, 2002

(30) Foreign Application Priority Data
Aug. 30, 2001 (JP) P. 2001-261306

(51) Int. Cl. C03C 13/00

(52) U.S. Cl. 501/35

(57) ABSTRACT

The invention provides an inorganic fiber comprising SiO₂, MgO and a manganese oxide as essential components, and having an amorphous portion comprising these essential components in its structure.

### FIELD OF THE INVENTION

This invention relates to inorganic fiber and a process of producing the same. It particularly relates to an inorganic fiber which is highly heat resistant and biosoluble in the body and dischargeable from the body. The invention also relates to a process of producing the inorganic fiber.

### BACKGROUND OF THE INVENTION

Inorganic fibers such as heat resistant glass fibers and ceramic fibers are widely used in heat insulation parts of various structures, such as buildings, because of their excellent heat resistance.

On the other hand, inorganic fibers are liable to be suspended in the air during manufacture, storage, transportation or working and can enter human bodies through inhalation. Of the inorganic fibers entering the body those with relatively large sizes are caught in the nasal cavity or the oral cavity and discharged out of the body together with snivel or saliva or swallowed into the digestive organs such as the stomach. Fine fibers, however, can pass through the nose or the mouth and reach the lungs and adhere to the alveoli (balloon-like gas exchanging structures).

In general, if foreign matter enters an alveolus of the lungs, alveolar macrophages surround the foreign matter and carry it to the places with cilia, i.e., the trachea and the bronchi so that it may be driven out with phlegm or make the foreign matter be discharged through lymph and lymphatic vessels. However, the macrophages can be irritated or damaged while surrounding foreign matter, resulting in release of proteolytic or collagenolytic enzymes therefrom. In the presence of excessive proteolytic or collagenolytic enzymes, the alveolar cells come to be inflamed or collagenated. Inflamed cells has reduced resistance, and DNA in the cellular nucleus becomes susceptible to damage. Besides, cell destruction and cell regeneration alternate frequently, giving increased opportunities to abnormal cells to emerge, which can induce denaturation of DNA cells or cancer development.

Hence inorganic fibers for the above-described applications have recently come to be required to have solubility in physiological liquids such as pulmonary liquid, i.e., biodegradability, as well as heat resistance. Various inorganic fibers have been proposed for meeting the requirement.

For example, JP-W-10-512232 (WO97/16386) discloses glass fiber which comprises silica (SiO₂) and magnesia (MgO) as essential components and zirconia (ZrO₂) as an optional component and exhibits heat resistance at 1260° C. or higher and non-resistance to physiological liquids. Of these components, magnesium is the most capable of dissolving in a living body, and silicon and zirconium follow in this order. Zirconium little dissolves.

In order to ensure safety of inorganic fiber in case of inhalation, it is needless to say that fibers of higher solubility in the body are more desirable. Although addition of an alkali metal oxide, e.g., Na₂O or K₂O, or an alkaline earth metal oxide, e.g., CaO, brings about increased solubility of fibers, an alkali content markedly reduces heat resistance of the fiber due to formation of low-melting compounds by the alkali.

### SUMMARY OF THE INVENTION

An object of the present invention is to provide an inorganic fiber having high heat resistance so as not to melt even at 1400° C. and excellent biosolubility as compared with conventional ones.

Another object of the present invention is to provide a process for producing such an inorganic fiber.

Other objects and effects of the invention will become apparent from the following description.

The above-described objects have been achieved by providing:

An inorganic fiber comprising SiO₂, MgO and a manganese oxide as essential components, and having an amorphous portion comprising these essential components in its structure; and

A process of producing an inorganic fiber comprising: heating a raw material mixture comprising SiO₂, MgO and a manganese oxide at 1700 to 2000° C. to obtain a melt; and fiberising the melt by quenching.

### BRIEF DESCRIPTION OF THE DRWAINGS

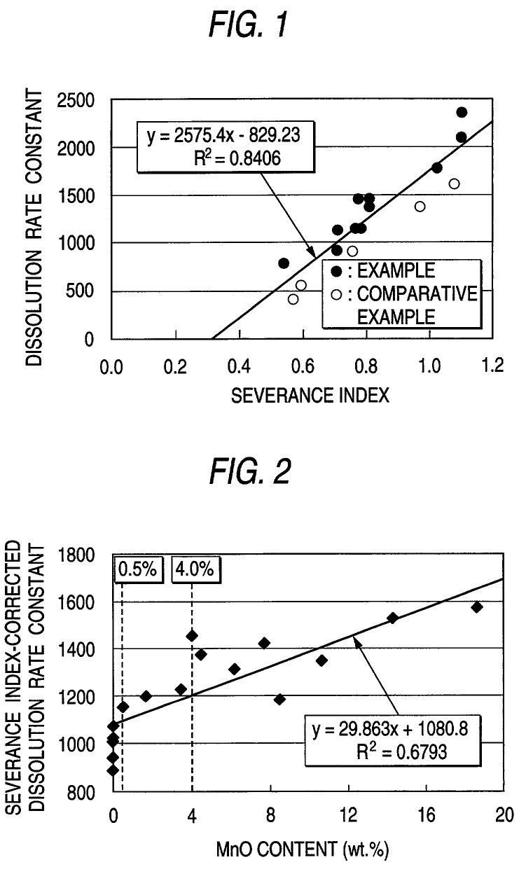

FIG. 1 graphically shows the relationship between severance of fiber network structure and dissolution rate constant of inorganic fibers prepared in Examples and Comparative Examples.

FIG. 2 graphically shows the influence of MnO content on dissolution rate constant exclusive of the influence of fiber network severance, as observed in Examples and Comparative Examples.

### DETAILED DESCRIPTION OF THE INVENTION

The present invention will be described with reference to the accompanying drawings.

The basic composition of the inorganic fiber according to the invention essentially comprises SiO₂, MgO, and a manganese oxide. The term “manganese oxide” as used herein denotes MnO, MnO₂ or both.

It has been said that solubility of inorganic fiber relies on the alkali metal oxide or alkaline earth metal oxide content in the fiber. This is attributed to the process of producing inorganic fiber. That is, inorganic fiber is manufactured by melting raw materials and cooling the melt by an appropriate means into a fibrous amorphous structure. In the melt an aggregate of components forming nuclei of fibers, such as SiO₂ and Al₂O₃, forms a firm network structure, which is maintained in the fibers obtained by cooling the melt. Where an alkali metal oxide, e.g., Na₂O or K₂O, or an alkaline earth metal oxide, e.g., CaO, is present in the melt, the network structure is to be severed into small aggregates. In case such inorganic fiber enters the body and receives attack of H₊ or OH⁻ in a biological liquid, the network structure is cut, and the force of restraining fiber-forming components in the fiber structure is thus weakened to permit the components to dissolve out.

Taking advantage of the above-mentioned mechanism, it has been a practice mainly followed to add an alkali metal oxide or an alkaline earth metal oxide as a component for increasing biosolubility. In some cases P₂O₅ or Fe₂O₃ has been added for the same purpose. A manganese oxide, an essential component in the present invention, has hitherto been regarded as an unavoidable impurity. The present inventors have found that incorporation of a prescribed amount of a manganese oxide brings about great improvement on biosolubility of inorganic fiber.

Of alkali metal oxides and alkaline earth metal oxides effective to increase biosolubility of inorganic fibers, beryllium oxide (BeO) is the most effective on heat resistance as evaluated in terms of eutectic temperature of a system combined with SiO₂. Nevertheless a beryllium compound is unsuitable as a material of biosoluble fibers on account of its high toxicity. The second best (having the second highest eutectic temperature) is MgO, whose eutectic temperature with SiO₂ is 1543° C., which is higher than that of an SiO₂—CaO system by 100° C. or more. Accordingly, it is essential to combine SiO₂ and MgO in order to enhance the heat resistance of inorganic fiber as well as biodegradability. However, if the SiO₂—MgO system contains any one of Na₂O, K₂O, CaO, SrO, P₂O₅, and Fe₂O₃, the heat resistance is impaired, and the resulting system melts below 1400° C. This is because these components form low-melting compounds whose melting point is below 1400° C. with SiO₂, MgO or both.

To the contrary, incorporation of a manganese oxide improves biosolubility without impairing the high heat resistance of the SiO₂—MgO system. This is because a manganese oxide does not form low-melting compounds with SiO₂ and/or MgO unlike Na₂O, K₂O, CaO, SrO, P₂O₅, Fe₂O₃, etc.

In order to obtain an inorganic fiber which mainly comprises SiO₂ and MgO and exhibits not only such heat resistance not to melt at 1400° C. but higher biosolubility than other inorganic fibers mainly comprising SiO₂ and MgO, it is preferred for the inorganic fiber to comprise at least 60% by weight (more preferably 60 to 80% by weight) of SiO₂, and at least 15% by weight (more preferably 15 to 30% by weight) of MgO. It is also preferred for the inorganic fiber to comprise 0.5 to 20% by weight, in terms of MnO, of a manganese oxide. A still preferred composition comprises 65 to 80% by weight of SiO₂, 15 to 28% by weight of MgO, and 2 to 20% by weight, in terms of MnO, of a manganese oxide. A particularly preferred composition comprises 65 to 80% by weight of SiO₂, 15 to 28% by weight of MgO, and 4 to 20% by weight, in terms of MnO, of a manganese oxide. An especially preferred composition comprises 70 to 80% by weight of SiO₂, 15 to 28% by weight of MgO, and 4 to 20% by weight, in terms of MnO, of a manganese oxide.

SiO₂ is a component forming the basic network structure of the inorganic fiber and making a great contribution to heat resistance. An SiO₂ content less than 60 wt % results in poor heat resistance. An SiO₂ content more than 80 wt % may result in too high a melt viscosity, which can interfere with fiberising.

MgO is not only essential for executing the process of quenching the melt into amorphous fibers similarly to SiO₂ but contributory to biosolubility of the inorganic fiber because it has higher biosolubility than SiO₂. An MgO content lower than 15 wt % makes fiberising difficult. Where the MgO content exceeds 30 wt %, the amounts of the other components tend to be insufficient for manifesting their full effects.

The manganese oxide is more effective in improving biosolubility than MgO and becomes more effective in proportion to its content as will be demonstrated in Examples described later. The manganese oxide is also effective to lower the viscosity of the melt and is preferred for smoothly carrying out fiberising. To have these effects revealed, the manganese oxide is preferably used in an amount of at least 0.5% by weight in terms of MnO. An MnO content more than 20% by weight results in an unfavorable viscosity of the melt for fiberising.

Besides being biosoluble as described above, the inorganic fiber of the present invention is equal or superior in heat resistance to inorganic fibers of related art. The inorganic fiber in the above-described range of composition has as low a percent shrinkage as 5% or less when heated at 1200° C. for 8 hours, which is sufficient for practical use. The inorganic fiber in the above-described range of composition retains its fibrous shape even when heated at 1400° C. for 8 hours as demonstrated in Examples given hereunder. Seeing that heat resistance owes basically to SiO₂, the SiO₂ content can be increased within the above-recited range where heat resistance is of particular interest.

If desired, the inorganic fiber of the invention may contain other components in addition to SiO₂, MgO, and the manganese oxide. For instance, it may contain up to 10% by weight of TiO₂. TiO₂ can be seen as effective because of its action of improving the dischargeability of the inorganic fiber from pulmonary alveoli. The inorganic fiber may further contain up to 10% by weight of ZrO₂. ZrO₂ has little influence on fiber physical properties but is effective to improve the yield in fiberising. Note that incorporation of more than 10 wt % of TiO₂ or ZrO₂, which means, of necessity, reduction of relative contents of other components, lessens the effects of the other components especially the manganese oxide. In particular, addition of more than 10 wt % of ZrO₂ abruptly increases the viscosity of the melt, which results in a failure to fiberise stably.

Raw materials which are used in the present invention are not particularly limited. While incorporation of impurities originated in raw materials is unavoidable, it is advisable to limit an Al₂O₃ content to 2% by weight or less and a CaO content to 3% by weight or less. Al₂O₃ reacts with SiO₂ to form aluminosilicates, which cause the resulting inorganic fiber to have reduced biosolubility. CaO reacts with SiO₂ to form low-melting compounds, which cause the resulting fiber to have reduced heat resistance. Further, presence of too much alkali metal or alkaline earth metal oxides, such as Na₂O, K₂O, and BaO, reduces the heat resistance of the fiber. Accordingly, it is desirable that these oxides be present in an amount not more than 0.5% by weight each or not more than 2% by weight in total.

The inorganic fiber of the present invention is obtained by heating a raw material mixture to a high temperature between 1700° and 2000° C. and fiberising the melt by quenching. Fiberising by quenching is effected by, for example, blowing or spinning. The raw materials which can be used in the invention include not only pure materials but silica sand as an SiO₂ source; magnesite, magnesia clinker, olivine, and olivine sand as an MgO source; manganese dioxide, soil manganese, manganese ore, rhodonite, and tephroite as an MnO source; ilmenite, rutile sand, beach sand and sagenite as a TiO₂ source; and baddeleyite and zircon sand as a ZrO₂ source.

The present invention will now be illustrated in greater detail with reference to the following Examples and Comparative Examples, but the invention should not be construed as being limited thereto.

### EXAMPLES 1 TO 11 AND COMPARATIVE EXAMPLES 1 TO 11

Silica sand, magnesium oxide, and manganese dioxide were compounded at a predetermined ratio, and the mixture was melted in an electric oven at 1700 to 2000° C. The melt was fiberised by blowing. The composition of the resulting inorganic fiber is shown in Tables 1 and 2 below. In the tables “Others” means impurities originated in the raw materials, including alkali metals, alkaline earth metals except Ca and Mg, and iron oxides. Comparative Example 10 is a highly heat-resistant ceramic fiber commonly used in the art. Comparative Example 11 is a fiber classified as “category 0 (no carcinogenicity)” according to the European classification of biosolubility.

TABLE 1
Chemical Composition (wt %)

| Example | | | | | | |
|---|---|---|---|---|---|---|
| No. | SiO₂ | MgO | MnO | Al₂O₃ | CaO | Others |
| 1 | 73.9 | 20.8 | 4.5 | 0.6 | 0.2 | 0.1 |
| 2 | 72.5 | 24.5 | 1.7 | 0.9 | 0.2 | 0.1 |
| 3 | 72.2 | 22.9 | 3.5 | 1.1 | 0.2 | 0.1 |
| 4 | 77.8 | 16.7 | 4.0 | 1.1 | 0.2 | 0.2 |
| 5 | 65.4 | 25.1 | 8.6 | 0.5 | 0.2 | 0.3 |
| 6 | 70.4 | 21.0 | 7.7 | 0.4 | 0.2 | 0.2 |
| 7 | 69.5 | 19.2 | 10.6 | 0.5 | 0.2 | 0.1 |
| 8 | 69.1 | 15.8 | 14.3 | 0.4 | 0.2 | 0.1 |
| 9 | 60.5 | 19.2 | 18.7 | 0.9 | 0.2 | 0.4 |
| 10 | 74.3 | 23.2 | 0.5 | 1.1 | 0.3 | 0.5 |
| 11 | 64.2 | 28.2 | 6.2 | 0.9 | 0.2 | 0.3 |

TABLE 2
Chemical Composition (wt %)

| Compara. | | | | | | |
|---|---|---|---|---|---|---|
| Example | | | | | | |
| No. | SiO₂ | MgO | MnO | Al₂O₃ | CaO | Others |
| 1 | 56.3 | 19.6 | 22.6 | 1.1 | 0.2 | 0.2 |
| 2 | 59.2 | 24.3 | 15.3 | 0.9 | 0.2 | 0.1 |
| 3 | 77.0 | 14.8 | 6.8 | 1.0 | 0.2 | 0.2 |
| 4 | 81.2 | 15.6 | 2.0 | 0.9 | 0.2 | 0.1 |
| 5 | 78.1 | 20.8 | 0.1 | 0.7 | 0.2 | 0.0 |
| 6 | 68.7 | 29.7 | 0.1 | 0.8 | 0.2 | 0.5 |
| 7 | 66.9 | 32.2 | 0.0 | 0.6 | 0.2 | 0.1 |
| 8 | 74.1 | 25.0 | 0.1 | 0.6 | 0.2 | 0.0 |
| 9 | 78.0 | 19.9 | 0.0 | 0.1 | 0.2 | 0.8 |
| 10 | 51.5 | 0.0 | 0.0 | 48.2 | 0.0 | 0.3 |
| 11 | 77.7 | 18.9 | 0.0 | 2.2 | 0.3 | 0.9 |

Solubility Test:

Each of the inorganic fibers shown in Tables 1 and 2 was filtered through a 325 mesh sieve to remove particulate matter (commonly referred to as “shot”). An aliquot precisely weighing 0.1 g was put on filter paper laid on the mouth of a reservoir. Physiological saline having the formulation shown below was dropped thereon by use of a micropump at a rate of 0.3 ml/mn. While the physiological saline passed through the fiber on the filter paper, the fiber components were eluted out. The physiological saline was kept at 37° C. (the temperature of biological liquids). The eluate in the reservoir was taken out after 96 hours and analyzed with an ICP-AES apparatus to determine the amount of the solute (fiber components), from which the solubility of the fiber was calculated. Because a difference in fiber surface area due to a difference in fiber diameter is reflected on the thus obtained solubility, the fiber diameter was separately measured to obtain the surface area, for which the solubility was corrected to obtain a solubility per unit time per unit surface area (ng/cm².hr; hereinafter referred to as a dissolution rate constant).

Formulation of Physiological Saline:

| | |
|---|---|
| Water | 1 liter |
| Sodium chloride | 6.780 g |
| Ammonium chloride | 0.535 g |
| Sodium hydrogencarbonate | 0.268 g |
| Sodium dihydrogencitrate | 0.166 g |
| Sodium citrate dihydrate | 0.059 g |
| Glycine | 0.450 g |
| Calcium chloride | 0.022 g |
| Sulfuric acid | 0.049 g |
| pH = 7.4 | |

Heat Resistance Test:

Each of the inorganic fibers shown in Tables 1 and 2 was thoroughly disentangled. After particulate matter “shot” was removed, about 10 g of the fiber was put in a crucible without being pressed. The crucible was placed in an electric oven. The oven temperature was raised up to 1400° C. at a rate of 200° C./hr, at which the crucible was maintained for 8 hours. After cooling, the crucible was taken out of the oven, and the contents were evaluated with the naked eye and by the feel. The heat resistance was rated in terms of shape retention on an A-to-D scale as follows.

| | |
|---|---|
| A | The fiber shape is retained. The fiber |
| | shows flexibility. |
| B | The fiber shape is retained. The fiber |
| | shows poor flexibility. |
| C | The fiber shape is retained, but the fiber |
| | is ready to collapse on being pressed |
| | strongly. |
| D | The fiber is in a completely molten state. |

The test results obtained are shown in Table 3. Of the inorganic fibers those having an MnO content exceeding 10 wt % (Examples 7 to 9 and Comparative Example 2) were slightly inferior to those with an MnO content of 10 wt % or smaller in ease of fiberising but capable of providing fibers that were not inferior by controlling the electricity quantity of the electric oven. The composition of Comparative Example 1, which had an MnO content exceeding 20 wt %, had so low a viscosity that fiberising was difficult. As shown in Table 3, fibers containing a manganese oxide have a higher dissolution rate constant in physiological saline. Since biosolubility largely depends on the degree of severance of the fiber network structure as stated previously, the degree of severance of the network structure was standardized. That is, assuming that the components constituting the network are Si (SiO₂) and Al (Al₂O₃) and that the components severing the network are Mg (MgO), Ca (CaO), and Mn (MnO), the ratio of these components defined by the following equation is taken as a network severance index, simply “severance index”. From the concept of network severance, Si, Al, Mg, Ca, and Mn are represented in molar quantity.

Severance index=(Mg+Ca+Mn (mol %))/(Si+Al(mol %))

The severance index of the inorganic fibers of Examples 1 to 11 and Comparative Examples 5 to 9, which had been produced with ease and did not melt at 1400° C., were obtained. The severance index and the dissolution rate constant of these inorganic fibers are shown in Table 4, and their relationship is shown in FIG. 1. As shown in FIG. 1, while the dissolution rate constant is largely influenced by the severance index, there are observed sufficiently significant differences of dissolution rate constant between the inorganic fibers of Examples which contained manganese oxide and the comparative ones containing no or little manganese oxide. Hence, the influence of severance index on dissolution rate constant was excluded from the results as follows. The slope of the straight line depicted in FIG. 1, 2575.4, was taken as the degree of the influence by severance index. This value was used to calculate the dissolution rate constant at a severance index of 0.8 (hereinafter referred to as a severance index-corrected dissolution rate constant) according to equation:

$$Severance index - corrected dissolution rate constant = each dissolution rate constant - 2575.4 \times ( each severance index - 0.8 )$$

Analysis on the relationship between the severance index-corrected dissolution rate constant and the MnO content reveals the effects of the manganese oxide on dissolution rate constant. Table 5 shows the MnO contents and the severance index-corrected dissolution rate constants, and FIG. 2 represents the relationship between them. FIG. 2 indicates the influence of manganese oxide on severance index-corrected dissolution rate constant. Even as low an MnO content as 0.5% is effective, and presence of 4% or more of MnO produces a markedly increased effect. This seems to be because Mn is more effective than Mg in severing the inorganic fiber network structure and presence of 4% or more of MnO ensures the severing effect. The inorganic fibers of Examples are much superior in these parameters to the commonly used ceramic fiber of Comparative Example 10 and are superior even to the inorganic fiber of Comparative Example 11 which is classified as “category 0 (no carcinogenicity)”.

TABLE 3

| | Dissolution Rate | | |
|---|---|---|---|
| | Constant | Heat | |
| | (ng/cm² · hr) | Resistance | Fiberising |
| Example 1 | 1136 | A | possible |
| Example 2 | 1150 | A | possible |
| Example 3 | 1139 | A | possible |
| Example 4 | 790 | A | possible |
| Example 5 | 1755 | B | possible |
| Example 6 | 1438 | A | possible |
| Example 7 | 1370 | B | possible |
| Example 8 | 1459 | B | possible |
| Example 9 | 2339 | C | possible |
| Example 10 | 917 | A | possible |
| Example 11 | 2080 | C | possible |
| Compara. | — | D | difficult |
| Example 1 | | | |
| Compara. | — | D | possible |
| Example 2 | | | |
| Compara. | — | A | difficult |
| Example 3 | | | |
| Compara. | — | A | difficult |
| Example 4 | | | |
| Compara. | 554 | A | possible |
| Example 5 | | | |
| Compara. | 1369 | B | possible |
| Example 6 | | | |
| Compara. | 1600 | B | possible |
| Example 7 | | | |
| Compara. | 914 | A | possible |
| Example 8 | | | |
| Compara. | 414 | A | possible |
| Example 9 | | | |
| Compara. | 8 | A | commercial |
| Example 10 | | | article |
| Compara. | 339 | A | commercial |
| Example 11 | | | article |

TABLE 4

| | Severance | Dissolution Rate |
|---|---|---|
| | Index | Constant (ng/cm² · hr) |
| Example 1 | 0.708 | 1136 |
| Example 2 | 0.783 | 1150 |
| Example 3 | 0.766 | 1139 |
| Example 4 | 0.543 | 790 |
| Example 5 | 1.023 | 1755 |
| Example 6 | 0.808 | 1438 |
| Example 7 | 0.811 | 1370 |
| Example 8 | 0.776 | 1459 |
| Example 9 | 1.099 | 2339 |
| Example 10 | 0.706 | 917 |
| Example 11 | 1.099 | 2080 |
| Compara. | 0.597 | 554 |
| Example 5 | | |
| Compara. | 0.965 | 1369 |
| Example 6 | | |
| Compara. | 1.074 | 1600 |
| Example 7 | | |
| Compara. | 0.756 | 914 |
| Example 8 | | |
| Compara. | 0.569 | 414 |
| Example 9 | | |

TABLE 5

| | | Severance Index- |
|---|---|---|
| | MnO | Corrected Dissolution |
| | Content | Rate Constant |
| | (wt %) | (ng/cm² · hr) |
| Example 1 | 4.5 | 1374 |
| Example 2 | 1.7 | 1193 |
| Example 3 | 3.5 | 1228 |
| Example 4 | 4.0 | 1451 |
| Example 5 | 8.6 | 1182 |
| Example 6 | 7.7 | 1418 |
| Example 7 | 10.6 | 1342 |
| Example 8 | 14.3 | 1520 |
| Example 9 | 18.7 | 1569 |
| Example 10 | 0.5 | 1158 |
| Example 11 | 6.2 | 1310 |
| Compara. | 0.1 | 1078 |
| Example 5 | | |
| Compara. | 0.1 | 945 |
| Example 6 | | |
| Compara. | 0.0 | 895 |
| Example 7 | | |
| Compara. | 0.1 | 1027 |
| Example 8 | | |
| Compara. | 0.0 | 1009 |
| Example 9 | | |

With respect to heat resistance, the inorganic fibers of Comparative Examples 1 and 2 which had an SiO₂ content less than 60 wt % melted on heating at 1400° C. Those with an SiO₂ content of 60 wt % or more do not melt at 1400° C. as in Examples. It is seen that SiO₂ contents of 65 wt % or more secure sufficient heat resistance as in Examples except Examples 9 and 11 and that SiO₂ contents of 70 wt % or more ensure further improved heat resistance as in Examples 1 to 4, 6, and 10. The compositions of Comparative Examples 1, 3, and 4 encounter considerable difficulty in fiberising and are unfit for manufacture with existing apparatus.

### EXAMPLES 12 TO 15 AND COMPARATIVE EXAMPLES 12 TO 13

Silica sand, magnesium oxide, manganese dioxide, titanium oxide, and zircon sand were compounded at a predetermined ratio, and the mixture was melted at 1700 to 2000° C. The resulting melt was fiberised by blowing. The composition of the resulting inorganic fiber is shown in Table 6 below. In the tables “Others” means impurities originated in the raw materials, including alkali metals, alkaline earth metals except Ca and Mg, and iron oxides.

TABLE 6
Chemical Composition (wt %)

| | SiO₂ | MgO | MnO | Al₂O₃ | CaO | TiO₂ | ZrO₂ | Others |
|---|---|---|---|---|---|---|---|---|
| Example | 70.3 | 21.0 | 4.8 | 1.1 | 0.2 | 2.5 | 0.0 | 0.1 |
| 12 | | | | | | | | |
| Example | 65.7 | 20.5 | 2.6 | 0.9 | 0.2 | 9.8 | 0.0 | 0.2 |
| 13 | | | | | | | | |
| Example | 70.3 | 20.9 | 4.4 | 1.0 | 0.2 | 0.0 | 2.8 | 0.3 |
| 14 | | | | | | | | |
| Example | 65.5 | 20.6 | 2.7 | 1.0 | 0.2 | 0.0 | 9.7 | 0.2 |
| 15 | | | | | | | | |
| Compara. | 63.0 | 20.8 | 4.2 | 0.9 | 0.2 | 10.8 | 0.0 | 0.1 |
| Example | | | | | | | | |
| 12 | | | | | | | | |
| Compara. | 63.6 | 19.8 | 4.5 | 1.1 | 0.2 | 0.0 | 10.6 | 0.1 |
| Example | | | | | | | | |
| 13 | | | | | | | | |

Evaluation:

The dissolution rate constant and heat resistance of the resulting inorganic fibers were measured or evaluated in the same manner as in the foregoing Examples. The results obtained are shown in Table 7 below.

TABLE 7

| | Dissolution | | |
|---|---|---|---|
| | Rate Constant | Heat | |
| | (ng/cm² · hr) | Resistance | Fiberising |
| Example 12 | 1206 | A | possible |
| Example 13 | 1098 | B | possible |
| Example 14 | 887 | A | possible |
| Example 15 | 843 | B | possible |
| Compara. | — | C | difficult |
| Example 12 | | | |
| Compara. | — | C | difficult |
| Example 13 | | | |

As can be seen from the results of Examples 12 and 13, SiO₂—MgO—MnO systems having incorporated therein 10 wt % or less of TiO₂ still exhibit satisfactory biosolubility and maintain superiority to the inorganic fiber of Comparative Example 11, which is classified as “category 0 (no carcinogenicity)”. Analysis on these systems based on their severance indices revealed the same tendency as shown in FIG. 2. SiO₂—MgO—MnO systems having incorporated therein 10 wt % or less of ZrO₂ as in Examples 14 and 15 exhibited relatively low values in FIG. 2 when analyzed based on severance indices but are still superior to the inorganic fiber of Comparative Example 11, which is classified as “category 0 (no carcinogenicity)”. One of the effects of ZrO₂ addition is facilitating fiberising. Nevertheless addition of more than 10 wt % of TiO₂ or ZrO₂ to an SiO₂—MgO—MnO system resulted in an abrupt increase of viscosity of the melt, which adversely affected fiberising. The inorganic fibers of Examples 12 to 15 were as satisfactory in heat resistance as those of Examples 1 to 11. The fibers of Examples 12 and 13, which contained 70 wt % or more of SiO₂, exhibited high heat resistance.

The inorganic fibers according to the present invention exhibit equality or superiority in heat resistance and, owing to accelerated severance of fiber network structure, superiority in biosolubility to conventional inorganic fibers and therefore minimize adverse influences on a living body.

While the invention has been described in detail and with reference to specific examples thereof, it will be apparent to one skilled in the art that various changes and modifications can be made therein without departing from the spirit and scope thereof.

What is claimed is:

1. An inorganic fiber comprising SiO₂, MgO and a manganese oxide as essential components, and having an amorphous portion comprising these essential components in its structure.

2. The inorganic fiber according to claim 1, wherein the manganese oxide is present in an amount of 0.5 to 20% by weight.

3. The inorganic fiber according to claim 1, wherein SiO₂ is present in an amount of 60% by weight or more, and MgO is present in an amount of 15% by weight or more.

4. The inorganic fiber according to claim 1, wherein SiO₂ is present in an amount of 60 to 80% by weight, MgO is present in an amount of 15 to 30% by weight, and the manganese oxide is present in an amount of 0.5 to 20% by weight.

5. The inorganic fiber according to claim 1, wherein SiO₂ is present in an amount of 65 to 80% by weight, MgO is present in an amount of 15 to 28% by weight, and the manganese oxide is present in an amount of 4 to 20% by weight.

6. The inorganic fiber according to any one of claims 1 to 5, which is free of titanium dioxide and zirconium oxide.

7. A process of producing an inorganic fiber comprising:
heating a raw material mixture comprising SiO₂, MgO and a manganese oxide at 1700 to 2000° C. to obtain a melt; and
fiberising the melt by quenching.
